(19) United States
(12) Patent Application Publication
(10) Pub. No.: US 2008/0066600 A1
(43) Pub. Date: Mar. 20, 2008

(54) Punching Unit

(76) Inventor: Shinichi Mita, Ishikawa Pref (JP)

Correspondence Address: WENDEROTH, LIND & PONACK, L.L.P., 2033 K STREET N. W., SUITE 800, WASHINGTON, DC, 20006-1021, US

(21) Appl. No.: 11/664,815

(22) PCT Filed: Oct. 6, 2004
(86) PCT No.: PCT/JP04/14757

§ 371 Date: Apr. 6, 2007

(51) Int. Cl. B26F 1/14

(52) U.S. Cl. 83/691; 83/684

(57) ABSTRACT

An inventive punching unit is provided with punches (2) whose blade (2a) is cut away in a shape of V at a shearing angle (a) whose apex (b) is set at a position offset from an axial center line (O-O) of the punch (2) by a predetermined distance (c). Because the lengths of left and right edges (P3 and P4) of the blade (2a) are different and these edges (P3 and P4) contact with a sheet at staggered timing, a peak value of punching force of the punch (2) may be lowered. Thus, the peak values of the punch are lowered and hence a driving force is lowered.

### TECHNICAL FIELD

The present invention relates to a punching unit for punching holes in a sheet type member by means of punches and dies and more specifically to a punching unit suitably attached to an image forming apparatus such as a copying machine, a printer, a facsimile and a multi-function machine having their functions or to a printing machine.

### BACKGROUND ART

Hitherto, there has been known a punching unit, having a cam plate on which grooved cams of a predetermined shape is formed and punches engaging respectively with the grooved cams to be guided in the vertical direction, for punching holes in a sheet type member such as papers by vertically moving the punches by reciprocating the cam plate as disclosed in Japanese Patent Laid-Open No. 2001-198889. In the punching unit, a pin is fixed to each punch in the direction orthogonal to each other and is guided and supported movably in the vertical direction by a long hole of a frame. The pin is also engaged with the grooved cam, so that the punch moves in the vertical direction when the cam plate having the grooved cams slides and reciprocates in the lateral direction. As shown in FIG. 12, a blade 2a at the end of a punch 2 of the prior art is cut away in a shape of inverted V, when seen from the side thereof. Then, both edges P1 and P2 of the inverted V-shaped blade having the same height (length) h contact with the sheet member almost in the same time and shear and punch the sheet member in combination with the die.

### DISCLOSURE OF INVENTION

By the way, with the recent progress of performance of a copying machine and the like in terms of speed and durability, a punching unit that is built in a finisher, i.e., an attachment thereof, is also required to increase its speed and durability in the same manner.

Meanwhile, it is also required to downsize and to save power of the unit. Although it is possible to increase the punching speed and to punch holes in a large number of sheet members at once by increasing driving torque by using a larger motor, the size and power consumption of the unit increase in contrary.

It is therefore an object of the invention to provide a punching unit that solves the above-mentioned problems by changing the shape of the blade of the punch.

According to a first aspect of the invention (see FIGS. 5A through 5F for example), a punching unit (1) for punching a hole in sheet type members by means of a punch (2) which reciprocates in its axial direction and a stationary die (4, 11) is characterized in that a blade (2a) of the punch (2) is cut away in a shape of V at a predetermined shearing angle (a) and that an apex (b) of the shearing angle is set at a position offset from an axial center line (O-O) of the punch (2) by a predetermined distance (c).

Accordingly, since the blade (2a) of the punch (2) is cut away in the shape of V at the shearing angle having the apex at the position off set from the axial center line (O-O) of the punch (2), heights (length) of the left and right edges are different from each other. Then, since the left and right edges contact with the sheet member at staggered timing, the punching force is evened and its peak value may be lowered. Thus, it becomes possible to lower the driving peak torque of a motor and to use a smaller motor.

According to a second aspect of the invention (see FIGS. 6A through 6E for example), a punching unit (1) for punching a hole in sheet type members by means of a punch (2) which reciprocates in the axial direction and a stationary die (4, 11) is characterized in that a blade (2a) of the punch (2) is cut away in a shape of stepped V at an inner shearing angle (e) and an outer shearing angle (f) which is smaller than the inner shearing angle.

Accordingly, since the blade (2a) of the punch 2 is cut away at the stepped shearing angles, it becomes possible to sharply shear the sheet member at the smaller shearing angle and hence to lower the peak value of the punching force. Thereby, it becomes possible to lower the driving peak torque and to use a smaller motor.

Preferably, the inner shearing angle (e) is an obtuse angle and the outer shearing angle (f) is an acute angle in the punching unit of the second aspect of the invention (see FIG. 6E for example).

Accordingly, because the outer edge of the punch has the acute shearing angle, the sheet member may be punched more sharply with a lower punching force. Still more, because the inner edge has the obtuse shearing angle, the durability of the blade may be maintained.

Preferably, as shown in FIG. 1 for example, the punching unit (1) of the first or second aspect of the invention is provided with a plurality of the punches and a cam plate (5) reciprocating in the direction orthogonal to the moving direction of the punches (2) and having grooved cams (9); the grooved cams (9) have a plurality of V-shaped portions (V) engaging with the plurality of corresponding punches (2) to reciprocate the punches (2) in the axial direction; and distances (S) between the respective punches and the V-shaped portions corresponding thereto are different from each other.

Accordingly, since a number of the punches (2) contact with and punch the sheet member at staggered timing, it becomes possible to scatter the driving peak and to use a smaller motor in punching a plurality of holes by the plurality of punches.

Preferably, as shown in FIGS. 2 and 3 for example, the punching unit of the first or second aspect of the invention is provided further with:

a main frame (3) for storing the punch (2) and the cam plate (5) that reciprocates in the direction orthogonal to the moving direction of the punch and has grooved cams (9); and

a pin (7) planted to the punch (2) and chamfered by the both sides thereof to be fittingly inserted into a long hole (10) formed in the main frame (3) so that the chamfered faces contact therewith to guide the punch (2) movably in the axial direction and by engaging with the grooved cam (9), to reciprocate the punch (2) in the axial direction.

Accordingly, since the chamfered portions (7a and 7b) for guiding the punch (2) are formed by the sides of the pin so that pin contacts with the long hole by the chamfered portions (7a and 7b), the pin contacts slidably with the long hole, which are both made of iron, with a large area, i.e., with a surface-to-surface contact. Thereby, it becomes possible to reduce a frictional force and to reduce power loss as well as to reduce wear and to improve the durability.

Preferably, as shown in FIGS. 2 and 4 for example, the punching unit of the first or second aspect of the invention is characterized in that:

the punch (2) and cam plate (5) are stored in a main frame (3);

the cam plate (5) reciprocates in the direction orthogonal to the moving direction of the punch and has grooved cam (9);

a guiding hole (6a or 6b) for guiding the punch (2) is formed in the main frame (3) so as to guide the punch (2) movably in the axial direction;

the punch (2) is engaged with the grooved cam (9) so as to reciprocate in the axial direction; and

a flange portion (13) is formed by means of burring around the guide hole (6b) of the main frame (3) on the side of the blade of the punch.

Accordingly, since the flange (13) is formed by means of burring around the guiding hole (6b) of the main frame (3) for guiding the blade of the punch, the blade (2a) may be thoroughly guided. Specifically, it prevents the blade of the first aspect of the invention whose one edge is longer than the other because the cut away-portion is offset or the blade of the second aspect of the invention whose edge is sharpened due to the stepped shearing angle from biting into the guiding hole. Thus, it is capable of reducing power loss that results in an increase of punching force and of preventing the guiding hole from being scraped and the durability from dropping.

It is noted that the reference numerals within the parentheses above are cited for the purpose of collation and will not by any means affect the description of the claims of the invention.

### BRIEF DESCRIPTION OF DRAWINGS

FIG. 1 is a front view showing a main part of a punching unit to which the invention is applicable;

FIG. 2 is a section view of a punch part taken along an axial line thereof;

FIG. 3 is an enlarged front view of a part for guiding the punch;

FIG. 4 is an enlarged front section view of a lower punch guiding hole section;

FIGS. 5A through 5F show a blade of a punch of a first embodiment of the invention, wherein FIG. 5A is a front view thereof, FIG. 5B is a left side view thereof, FIG. 5C is a front view thereof, FIG. D is a right side view thereof, FIG. 5E is a bottom view thereof, and FIG. 5F is a perspective view thereof;

FIGS. 6A through 6E show a blade of a punch of a second embodiment of the invention, wherein FIG. 6A is a front view thereof, FIG. 6B is a front view thereof, FIG. 6C is a side view thereof, FIG. 6D is a bottom view thereof and FIG. 6E is an enlarged front view thereof;

FIG. 7 is a table showing results of a comparative test on loads applied to the respective edges of blades of punches of the first and second embodiments of the invention and of a prior art;

FIG. 8 is a graph of the results of the comparative test;

FIG. 9 is a graph showing the result of the blade of the first embodiment;

FIG. 10 is a graph showing the result of the blade of the second embodiment;

FIG. 11 is a graph showing the result of the blade of the prior art unit; and

FIG. 12 is a front view showing the blade of the prior art punch.

### BEST MODES FOR CARRYING OUT THE INVENTION

Modes for carrying out the invention will be explained below with reference to the drawings.

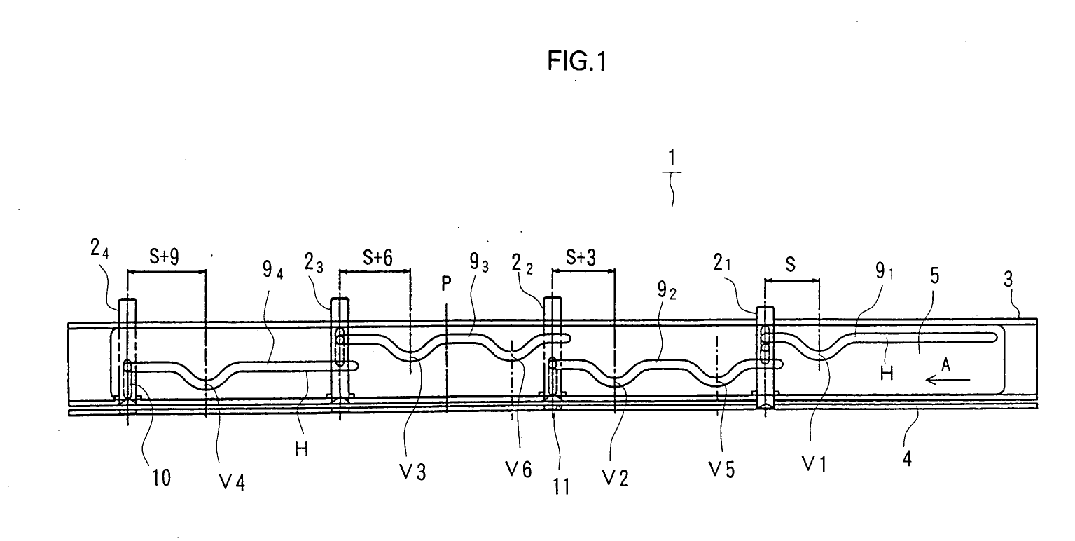

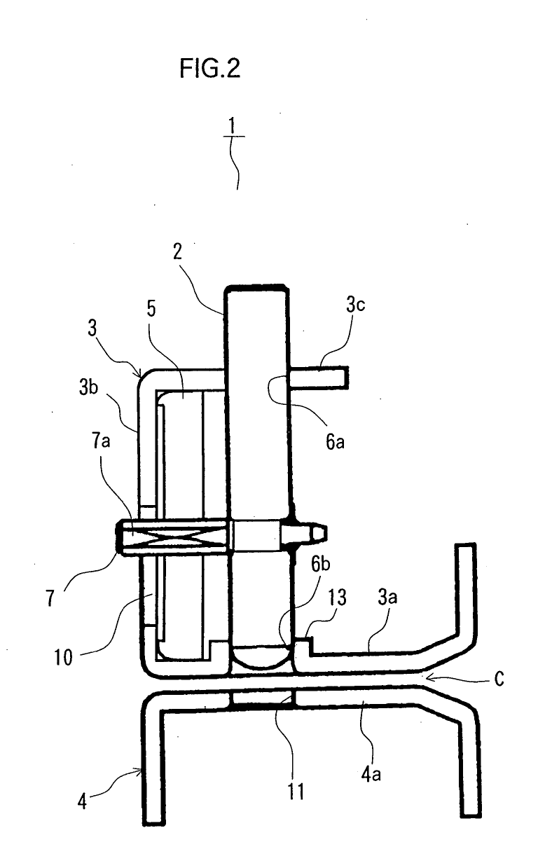

FIG. 1 is a front view showing a main part of a punching unit and FIG. 2 is a section view taken along a punch part. Driving devices such as a motor, a pinion and a rack are omitted in FIGS. 1 and 2. As shown in FIG. 2, the punching unit 1 has a main frame 3 for supporting a punch 2 and a die frame 4. The both frames 3 and 4 are fixed in a body so as to have a predetermined gap C between a bottom plate 3a of the main frame 3 and an upper plate 4a of the die frame 4 through an intermediary of spacers not shown.

A lengthy sliding cam plate 5 is stored in and supported by the main frame 3 in parallel with a side plate 3b of the main frame 3. The cam plate 5 reciprocates in the lateral direction in FIG. 1 by being driven by a driving unit not shown, i.e., a motor, a pinion linked with an output shaft of the motor and a rack fixed to the cam plate and engaging with the pinion. Holes 6a and 6b for supporting the punch are formed through an upper plate 3c and the bottom plate 3a of the main frame 3 so as to guide the punch 2 movably in the vertical direction. Still more, a pin 7 is planted to the punch 2 at right angles therewith.

As shown in FIG. 1, grooved cams 9 (four in the present mode) are formed in the cam plate 5 and (four) punches 2 are disposed in correspondence to the grooved cams 9. Still more, as shown in FIG. 2, (four) long holes 10 having a predetermined length and extending in the vertical direction are formed on the side plate 3b of the main frame 3. The pin 7 planted to each punch 2 engages with the grooved cam 9 and the long hole 10. Die holes 11 are formed through the die frame 4 in correspondence to the respective punches 2.

Accordingly, when the cam plate 5 reciprocates in the lateral direction by being driven by the driving unit and when the pin 7 that is permitted to move only in the vertical direction by the long hole 10 is engaged with the grooved cam 9, the punch 2 is driven in the vertical direction and in combination with the die, punches a hole in the sheet member such as a paper inserted into the gap C between the upper and lower frames 3 and 4. Here, there are the grooved cams 9₁ and 9₄ having one V-shaped portion and the grooved cams 9₂ and 9₃ having two V-shaped portions for vertically moving the punches. When the cam plate 5 slides in the left direction (in the direction of an arrow A) from a home position shown in FIG. 1, the V-shaped portions V1 through V4 of the respective grooved cams 9₁ through 9₄ cause the four punches 2₁ through 2₄ to move in the vertical direction, thus punching four holes in the sheet member. When the cam plate 5 slides further in the direction of the arrow A from a home position P where the cam plate 5 has been shifted in the left direction, the V-shaped portion V5 of the grooved cam 9₂ and the V-shaped portion V6 of the grooved cam 9₃ cause the two punches 2₂ and 2₃ to move in the vertical direction, thus punching two holes in the sheet member. It is noted that the other punches 2₁ and 2₄ are kept up as the pins 7 move to horizontal portions H.

Then, distances from the respective punches 2 to the V-shaped portions V of the respective grooved cams 9 are shifted (differentiated) among each other. That is, when the distance from the first punch 2₁ to the V-shaped portion V1 of the first grooved cam 9₁ is defined as S, the distance from the second punch 2₂ to the V-shaped portion V2 of the second grooved cam 9₂ is set as (S+3 mm), the distance from the third punch 2₃ to the V-shaped portion V3 of the third grooved cam 9₃ is set as (S+6 mm), and the distance from the fourth punch 2₄ to the V-shaped portion V4 of the fourth grooved cam 9₄ is set as (S+9 mm).

Thereby, when the cam plate 5 slides in the direction of the arrow A from the home position shown in FIG. 1, the first punch 2₁ reaches at first to the V-shaped portion V1 and drops and starts to punch the sheet member, the second punch 2₂ reaches then to the V-shaped portion V2 and drops and starts to punch the sheet member, the third punch 2 reaches further to the V-shaped portion V3 and drops and starts to punch the sheet member and finally the fourth punch 2₄ reaches to the V-shaped portion V4 and drops and starts to punch the sheet member.

Because the respective punches 2 sequentially contact with the sheet member and start to punch as described above, the punching force of the punches 2 may be scattered and a peak torque of the driving motor may be lowered by staggering the operating timing of the respective punches 2, as compared to a prior art punching unit that causes punches to contact all together with a sheet member and to start punching concurrently. It is noted that the case of punching four holes by the four punches has been explained above, it is needless to say that the same applies to a case of punching two holes as well as to a case of punching other number of holes such as three holes. It is also needless to say that the shift of timing of the respective punches is not limited to be 3, 6 or 9 mm described above and that it may be other numerical values.

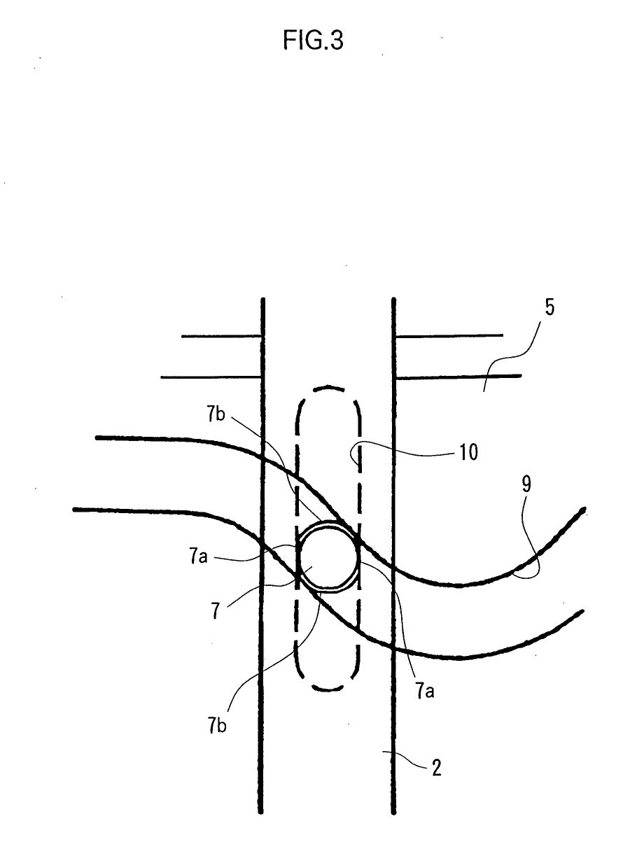

Meanwhile, the pin 7 planted to the punch 2 penetrates through the punch 2 and is secured by a bolt or the like as shown in detail in FIGS. 2 and 3. The both side faces 7a of a part of the pin 7 projecting from the punch 2 are chamfered and hence the pin 7 has an oval-shaped section. Then, the pin 7 is inserted into the long hole 10 so that the both chamfered portions 7a of a flat plane fit therewith and upper and lower round hole portions 7b engage with the grooved cam 9 of the cam plate 5.

Thereby, the pin 7 and the long hole 10 for vertically guiding the punch 2 contact each other with a larger contact area because the chamfered portions 7a of the pin 7 contact with the long hole 10 in a manner of surface-to-surface contact as compared to the point-to-point (line-to-line) contact of a prior art pin having a circular section. Therefore, it becomes possible to suppress abrasion of sliding portions of the pin and the long hole of the frame, both made of steel. It is noted that because the upper and lower faces of the pin 7 remain to be arched face even when the chamfered portion 7a is formed and because the arched faces 7b engage with the grooved cam 9 of the cam plate 5, the pin 7 is smoothly guided along the curved face of the grooved cam 9.

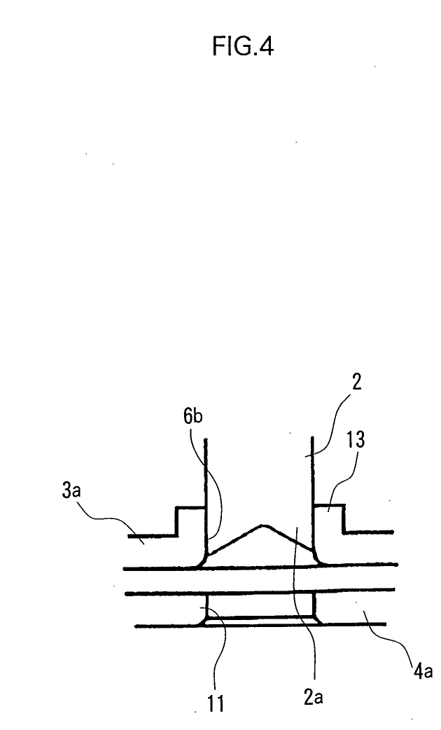

Still more, as shown in FIG. 4 in detail, a flange 13 that protrudes upward is formed around a punch lower guiding hole 6b of the main frame by burring the bottom plate 3a.

Accordingly, since the burred flange 13 having a predetermined length in the vertical direction thoroughly guides the blade 2a of the punch 2, it becomes possible to eliminate a possibility that the blade 2a bites into the punch lower guiding hole 6b, thus causing large power loss and scraping the guiding hole 6b. Specifically, although a difference of length (height) is produced between V-shaped edges P3 and P4 of the blade when a cut away portion of the blade of the punch is offset by a predetermined distance as described later and the possibility that the blade bites into and scrapes the lower guiding hole 6b increases in this case, it is possible to reliably prevent such troubles by guiding the blade 2a by the burred flange 13 described above.

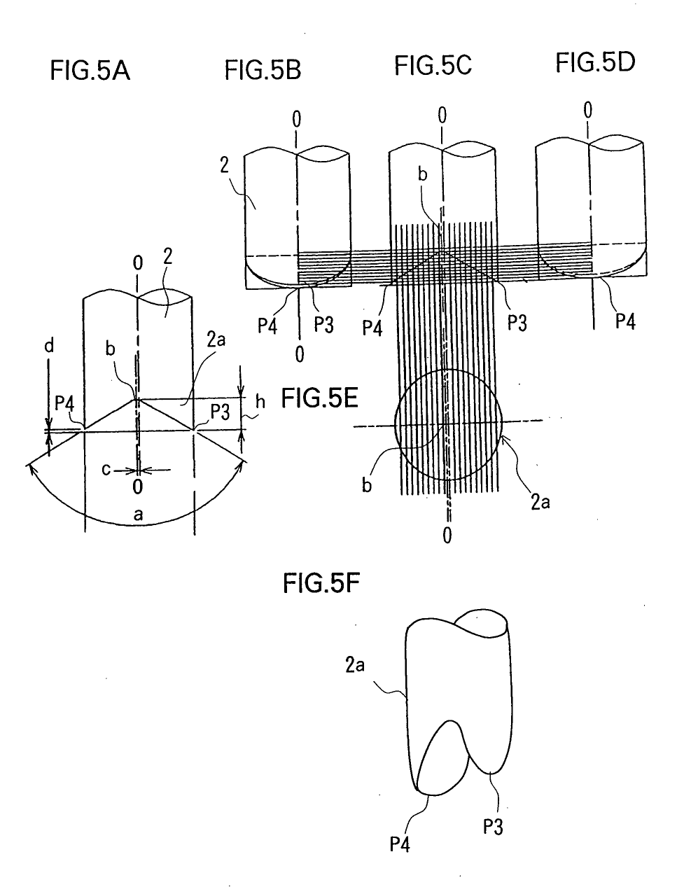

Next, the blade of the punch 2 that composes the main part of the invention (first embodiment) will be explained with reference to FIG. 5. The punch 2 has a circular section and its blade 2a is cut away in a shape of V. The V-shaped cut-away angle (shearing angle) a is around 60 to 140 degrees or is preferably about 120 degrees. Then, an apex portion b of the V-shaped cut-away angle is offset from a center line O-O of the punch by a predetermined distance c. The offset distance c is around 0.1 to 1.2 mm or is preferably about 0.2 mm. Accordingly, one edge P3 of the blade 2a is formed to be longer than the other edge P4 by a predetermined length d. It is noted that although the predetermined length d is determined by a radial size of the punch 2 and the offset distance c described above, it is preferable to be equivalent to a thickness of one sheet member to be punched. The blade 2a is V-shaped when seen from the front as shown in FIGS. 5A and 5C, its bottom is circular as shown in FIG. 5E, so that its left and right sides are arched-curved faces as shown in FIGS. 5B and 5D. In concrete, when a diameter of the punch 2 is 8Φ, its apex a is set at 120 degrees, the offset distance c of the apex is set at 0.2 mm and the difference d of the length of the both edge portions P3 and P4 is 0.23 mm. The difference d=0.23 mm is set to be equivalent to one sheet of normal paper (basis weight: 200 g) generally used. It is noted that lines in FIGS. 5B through 5E is graduated in 0.23 mm.

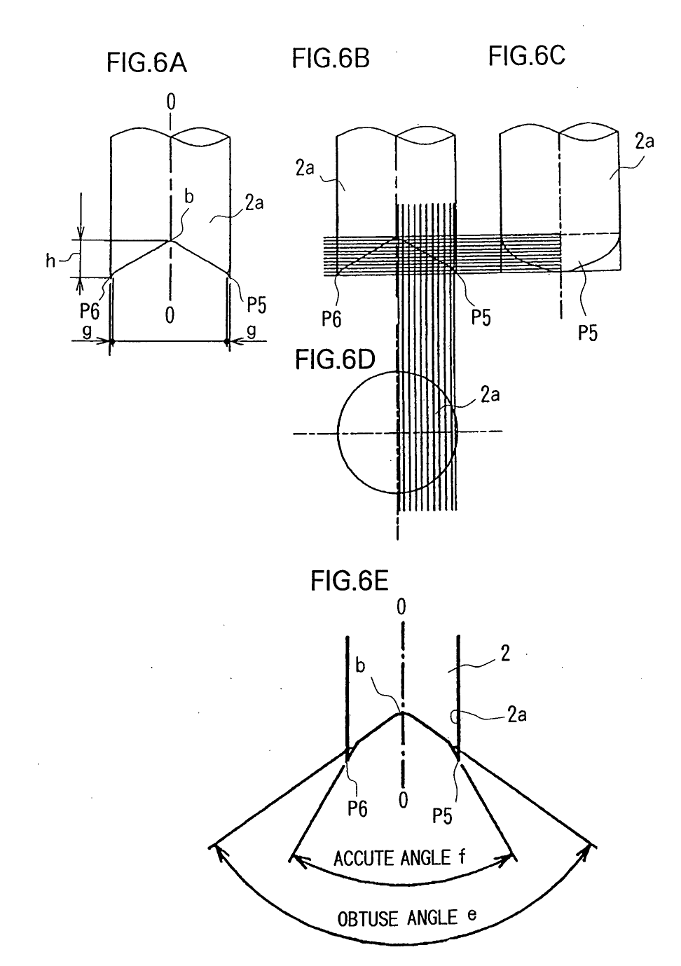

Next, a second embodiment of the invention will be explained with reference to FIGS. 6A through 6E. While an apex b of the blade 2a is positioned on the center line O-O of the punch, a V-shaped cut-away portion is stepped. That is, as shown in detail in FIG. 6E, an inner shearing angle is formed of an obtuse angle and an outer shearing angle is formed of an acute angle f. In concrete, the inner shearing angle e is preferable to be about 120 degrees and the outer shearing angle f to be about 60 degrees.

Thereby, the punch having the diameter of 8Φ has an acute portion g of 0.2 mm around the outer periphery of the blade, a height of the cut-away portion of 2.46 mm and the edges P5 and p6 having the same length. It is noted that the scale is 0.23 mm also in FIGS. 6B through 6D

It is also conceivable to form a punch having a blade having stepped shearing angles as shown in FIG. 6 and whose apex b is offset by a predetermined distance c as shown in FIG. 5.

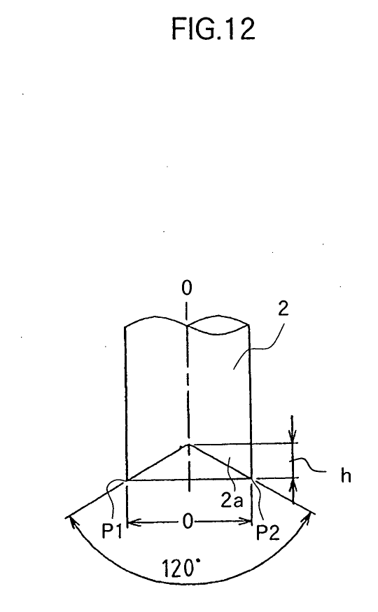

Next, an explanation will be made on results of comparison among the punch of the first embodiment shown in FIG. 5, the punch of the second embodiment shown in FIG. 6 and the punch of the prior art shown in FIG. 12. While all of the punches 2 have the diameter of 8 mm, the punch of the first embodiment has the shearing angle a of 120 degrees, the offset distance c of 0.2 mm, the edge P3 having the longer length h of 2.37 mm and the edge P4 having the shorter length d of 2.14 mm which is shorter than the longer one by 0.23 mm.

The punch of the second embodiment has the inner shearing angle f of 120 degrees, the outer shearing angle of 60 degrees, the width of the edge of 0.2 mm and the length h of the blade of 2.46 mm. The punch of the prior art has an apex on the center line O-O of the punch, a shearing angle of 120 degrees and length of the right and left edges P1 and P2 of both 2.33 mm.

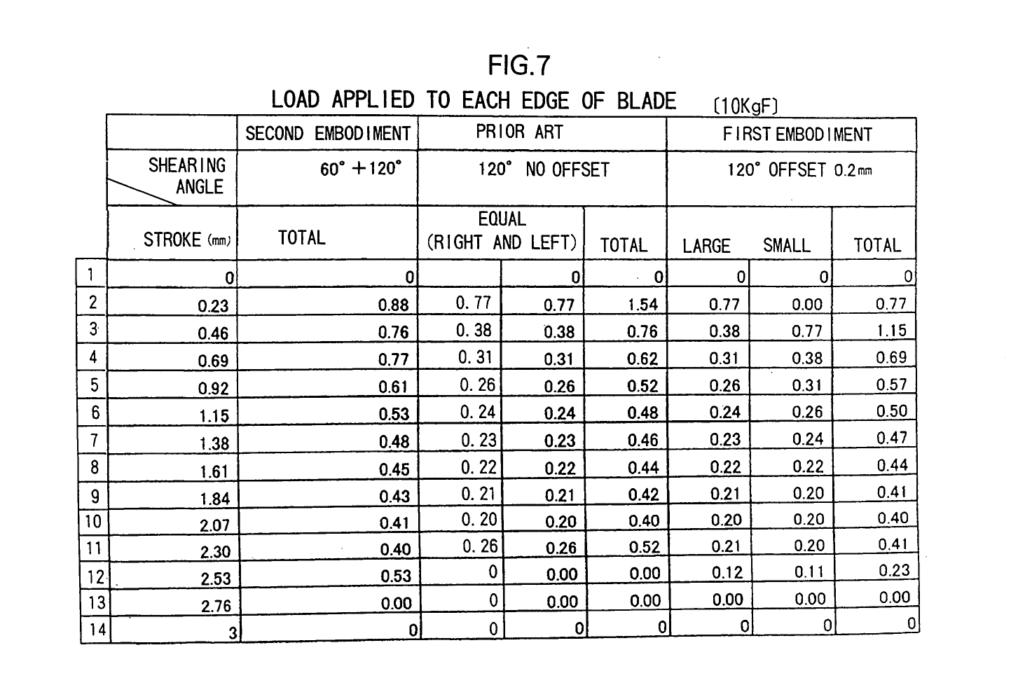

FIG. 7 is a table showing a load (punching force) [×10 Kgf] acting on the blade of the respective punches in punching a sheet of paper whose thickness is about 0.23 mm by using the punches having the blades of the second embodiment, the prior art and the first embodiment. It is noted that the blade 2a has two edges on the right and left due to the shearing angle. Because the right and left edges of the blade of the second embodiment have the same length, their total values of load are given in the table. Although the left and right edges of the blade of the prior art also have the same length, loads acting on the left and right edges P1 and P2 are separately given together with their total values in the table to compare with those of the first embodiment. As for the blade of the first embodiment, because the apex b is offset by the predetermined distance (c=0.2 mm) and the edge P3 is longer than the other edge by 0.23 mm, the both loads are given by showing that of the longer edge P3 as Large and that of the shorter edge P4 as Small, together with their total values.

It will be understood from the table in FIG. 7 that the load of the punch of the second embodiment having the stepped blade applied in starting punching is small and is evened and that it causes no large peak value, as compared to the blade of the prior art whose load applied in starting punching is particularly large. It is considered to have happened from a result that the first sheet of paper is sheared sharply by the edge having the acute outer shearing angle f.

Similarly, since the left and right edges of the blade, having the different lengths, of the punch of the first embodiment having the offset shearing angle contact with the sheet of paper in offset and the loads are different at the left and right (Large and Small) edges, the load of the punch of the first embodiment in which only one edge contacts with the sheet is small and is evened as a whole and its peak value is small, as compared to the punch of the prior art whose left and right edges contact with the sheet of paper in the same time in starting punching.

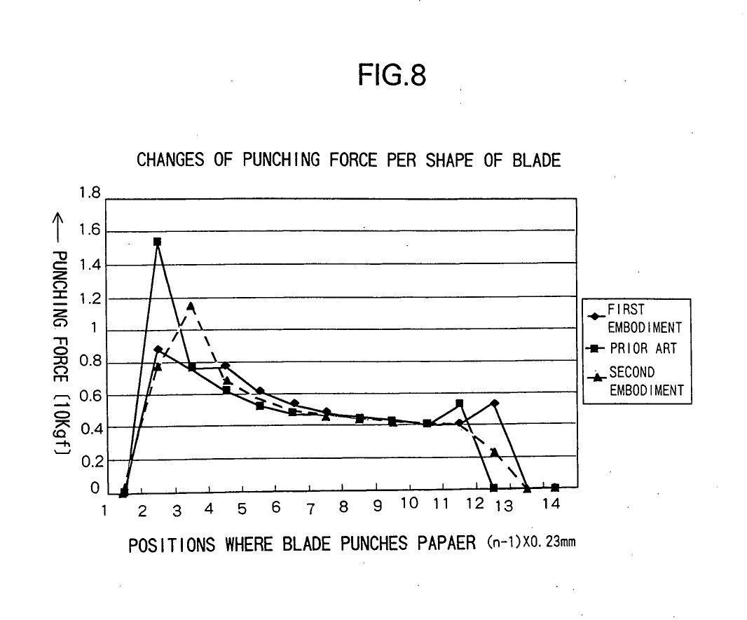

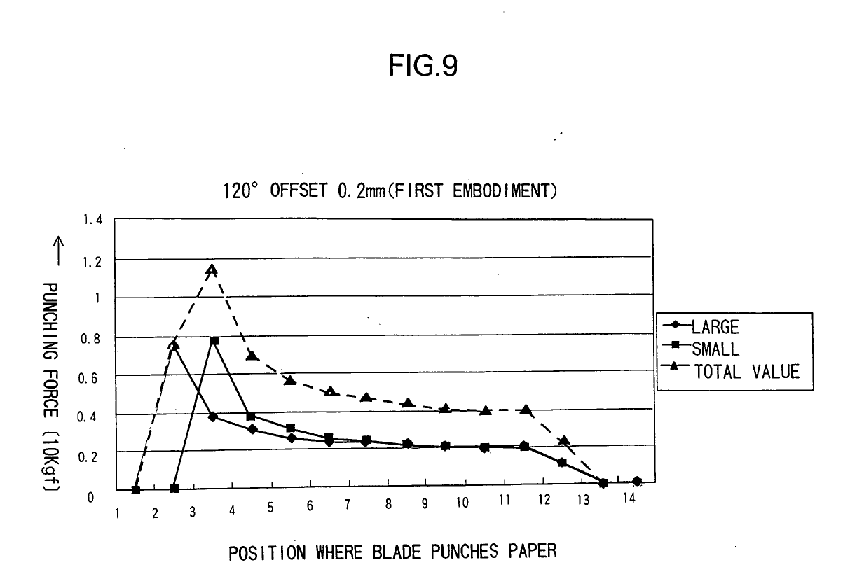

FIG. 8 is a graph showing the total values of FIG. 7 and it is understood from the graph that the loads of the punches of the first and second embodiments are evened and that specifically the punching force in starting punching of the sheet of paper is small, as compared to the punch of the prior art. It is noted that in the graph, an axis of ordinates indicates the punching force (×10 Kgf) of the punch and an axis of abscissa indicates the position [(n−1)×0.23 mm] where the blade perforates the papers. It is noted that the axes of ordinates and abscissa in FIGS. 9, 10 and 11 also indicate the punching force and the position in the same manner.

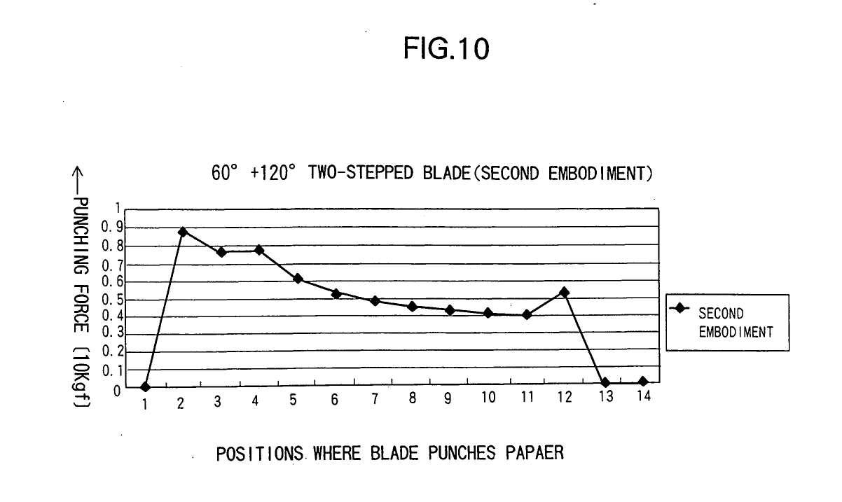

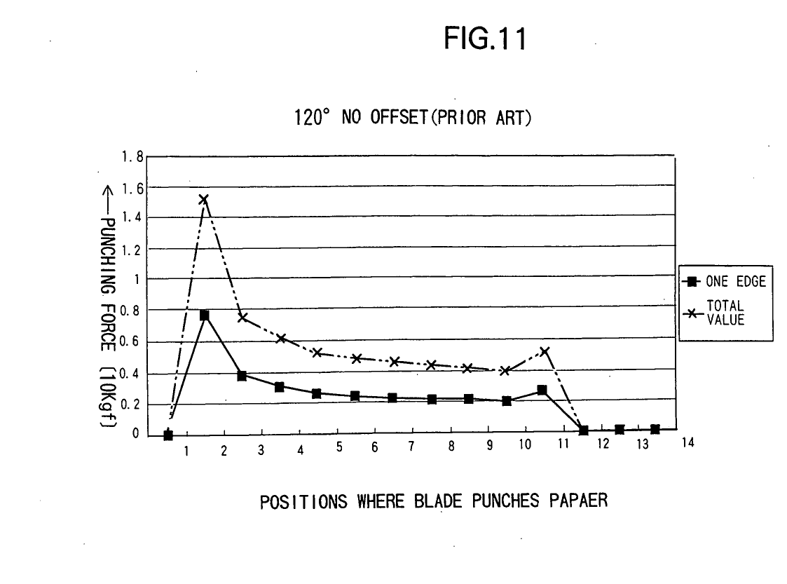

FIG. 9 is a graph showing the loads of the longer edge (Large), the shorter edge (Small) and their total values of the punch of the first embodiment, FIG. 10 is a graph showing the total value of load of the punch of the second embodiment and FIG. 11 is a graph showing the load of one edge and of the total value of the both edges of the punch of the prior art. It is understood from the figures that the loads of the punches of the first and second embodiments are evened and that their peak values are small as compared to that of the prior art.

While it will be understood that the peak value of the punching force may be lowered, the peak torque of the driving motor may be reduced, the processing speed may be increased by using a smaller motor and power consumption may be reduced by reducing the punching torque of the punch by changing the shape of the blade as described above, the punching peak torque may be reduced further by staggering the operating timing of the respective punches as explained with reference to FIG. 1.

Still more, it is possible to prevent the blade from biting into the guiding hole 6b, from causing a large sliding resistance or from scraping the guiding hole 6b, by chamfering the pin 7 as shown in FIGS. 2 and 3 so as to increase the contact area with the long hole 10, to reduce the abrasion caused by the iron-to-iron contact and to reduce the abrasion resistance, and by forming the burred flange 13 around the lower punch guiding hole 6b as shown in FIG. 4 when it is applied to the blade 2a and specifically to the blade whose both edges P3 and P4 have different lengths as shown in FIG. 5 and to the blade whose outer shearing angle f is acute as shown in FIG. 6. It allows the sliding resistance to be reduced, the smaller motor to be used and the durability of the unit to be improved. As a whole, the size of the punching unit may be downsized, the speed thereof may be increased, its energy consumption may be reduced and its life may be prolonged.

It is noted that while the embodiments described above have been explained about what is applied to the punching unit of the type that vertically moves the punches by reciprocating the cam plate, the invention with regard the shape of the blade is also applicable to a punching unit driven by another driving mechanism such as what vertically moves punches by means of rotary cams.

1-5. (canceled)

6. A punching unit for punching a hole in sheet type members by means of a punch that reciprocates in its axial direction and a stationary die, wherein
a blade of said punch is cut away in a shape of V at a predetermined shearing angle and an apex of said shearing angle is set at a position offset from an axial center line of said punch by a predetermined distance.

7. A punching unit for punching a hole in sheet type members by means of a punch that reciprocates in its axial direction and a stationary die, wherein
a blade of said punch is cut away in a shape of stepped V at an inner shearing angle and an outer shearing angle which is smaller than said inner shearing angle.

8. The punching unit as set forth in claim 7, wherein said inner shearing angle is an obtuse angle and said outer shearing angle is an acute angle.

9. The punching unit as set forth in claim 6, further comprising:
a plurality of said punches; and
a cam plate reciprocating in the direction orthogonal to the moving direction of said punches and having grooved cams;
said grooved cams having a plurality of V-shaped portions engaging with corresponding ones of said plurality of punches to reciprocate said punches in the axial direction; and
distances between said respective punches and said V-shaped portions corresponding thereto being different from each other.

10. The punching unit as set forth in claim 6, further comprising:
a main frame for storing said punch and a cam plate that reciprocates in the direction orthogonal to the moving direction of said punch and has grooved cams; and
a pin planted to said punch and chamfered by the both sides thereof to be fittingly inserted into a long hole formed in said main frame so that said chamfered faces contact therewith to guide said punch movably in the axial direction and by engaging with said grooved cam, to reciprocate said punch in the axial direction.

11. The punching unit as set forth in claim 6, further comprising:
a main frame for storing said punch and a cam plate that reciprocates in the direction orthogonal to the moving direction of said punch and has grooved cams for reciprocating said punch in the axial direction by engaging therewith;
guide holes formed in said main frame for guiding said punch movably in the axial direction; and
a flange formed by means of burring around said guide hole of said main frame on the side of the blade of said punch.
